(19) United States
(12) Patent Application Publication
(10) Pub. No.: US 2024/0110437 A1
(43) Pub. Date: Apr. 4, 2024

(54) Under Door Seal

(71) Applicant: Oak Properties , LLC, Oklahoma City, OK (US)

(72) Inventors: Kipp Colllins, Oklahoma City, OK (US); Reid Wise, Edmond, OK (US); Reed Reutlinger, Edmond, OK (US); Tom Creighton, Oklahoma City, OK (US); James Schlect, Oklahoma City, OK (US); Kyle Neugebauer, Edmond, OK (US); Jared Bringhurst, Edmond, OK (US)

(73) Assignee: Oak Properties , LLC, Oklahoma City, OK (US)

(21) Appl. No.: 18/369,654

(22) Filed: Sep. 18, 2023

Related U.S. Application Data
(60) Provisional application No. 63/407,658, filed on Sep. 17, 2022.

(51) Int. Cl. E06B 7/23

(52) U.S. Cl. CPC E06B 7/2316

(57) ABSTRACT

An under door seal for interior doors. The under door seal has a U-shaped base unit and a plurality of sealing fins. The base unit mounts to the bottom of a door. The sealing fins are provided to seal a gap between the bottom of the door and the floor to block drafts, light, and sound from passing under the door. The sealing fins have a coiled shape configuration and flexible nature to allow the fins to extend or compress to fill a gap of varied height beneath the door. The flexible nature of the sealing fins also permits the under door seal to seal gaps between multiple floor levels and a single door bottom.

### FIELD OF THE INVENTION

The present invention relates to seals for interior doors and more particularly to slide on door bottom seals.

### BACKGROUND OF THE INVENTION

Interior doors is in residences and other buildings often present with gaps between a door bottom and door thresholds or floor types. The gaps provide opportunities for air drafts, light, and sound to pass beneath a closed door. Sealing gaps beneath door bottoms, particularly where a door spans multiple floor types or floors of different levels, is considered advantageous. The present invention provides a slide on under door seal to seal the gaps beneath interior doors.

### SUMMARY OF THE INVENTION

The present invention is directed to an under door seal. The door seal comprises an elongate U-shaped base unit, a first sealing fin, and a second sealing fin. The base unit is formed by a bottom base, a first vertical wall, and a second vertical wall. The base unit comprises a first channel guide extending from the first vertical wall and a second channel guide extending from the second vertical wall. The first vertical wall and the first channel guide define a first channel adjacent the first vertical wall, and the second vertical wall and the second channel guide define a second channel adjacent the second vertical wall. The first sealing fin comprises a rigid channel insert and a flexible fin comprising a plurality of leg segments that approximate a spiral shape. The second sealing fin comprises a rigid channel insert and a flexible fin comprising a plurality of leg segments that approximate a spiral shape. The first sealing fin is attached to the base unit by inserting the rigid channel insert into the first channel and the second sealing fin is attached to the base unit by inserting the rigid channel insert into the second channel.

In an alternative embodiment the invention is directed to an under door seal. The door seal comprises an elongate U-shaped base unit, a first sealing fin, and a second sealing fin. The base unit is formed by a bottom base, a first vertical wall, and a second vertical wall. The base unit comprises a plurality of longitudinal wall ridges protruding from an internal surface of the first vertical wall, a plurality of longitudinal wall ridges protruding from an internal surface of the second vertical wall, a first channel guide extending from the first vertical wall, and a second channel guide extending from the second vertical wall. The wall ridges of the first vertical wall are spaced vertically on the first vertical wall proximate a top edge of the wall and the wall ridges of the second vertical wall are spaced vertically on the second vertical wall proximate a top edge of the wall. The first vertical wall and the first channel guide define a first channel adjacent the first vertical wall. The second vertical wall and the second channel guide define a second channel adjacent the second vertical wall. The first sealing fin comprises a rigid channel insert and a flexible fin. The second sealing fin comprises a rigid channel insert and a flexible fin. The flexible fin of each of the first sealing fin and the second sealing fin each comprise a first leg extending in a first direction from a bottom of the channel insert, a second leg extending from a terminal end of the first leg to form an acute angle with the first leg, and a third leg extending from a terminal end of the second leg to form an acute angle with the second leg. The first sealing fin is attached to the base unit by inserting the rigid channel insert into the first channel. The second sealing fin is attached to the base unit by inserting the rigid channel insert into the second channel.

### BRIEF DESCRIPTION OF THE DRAWINGS

FIG. 1 is an isometric view of an under door seal constructed in accordance with the present invention.

FIG. 2 is an end view of the base unit for the under door seal depicted in FIG. 1.

FIG. 3 is an end view of a representative sealing fin for the under door seal depicted in FIG. 1.

FIG. 4 is an end view of the under door seal shown in position on the bottom section of a door.

FIG. 5 is an end view of the under door seal in a position spanning two floor levels beneath the door.

### DETAILED DESCRIPTION OF THE INVENTION

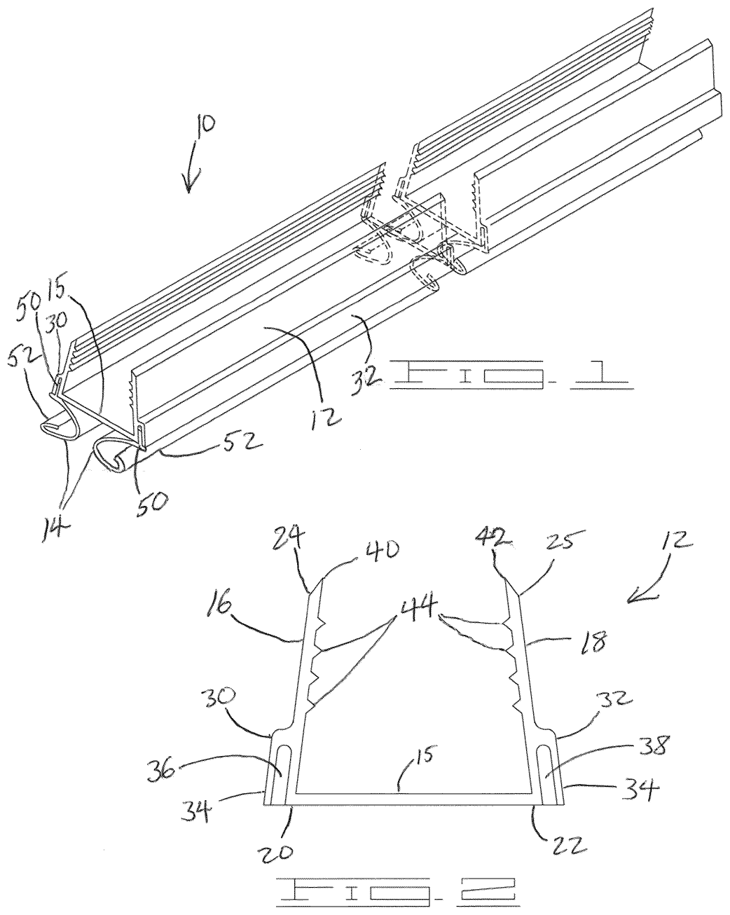

With reference now to the drawings in general and to FIG. 1 in particular, there is shown therein a preferred embodiment for an under door seal constructed in accordance with the present invention. The under door seal, designated by reference number 10, comprises an elongate U-shaped base unit 12 and a plurality of sealing fins 14 removably attached to the base unit. The under door seal 10 is provided for attachment to the bottom of an interior door (not shown) to seal gaps of different sizes beneath the door or for different gaps for multiple floor surfaces beneath the door.

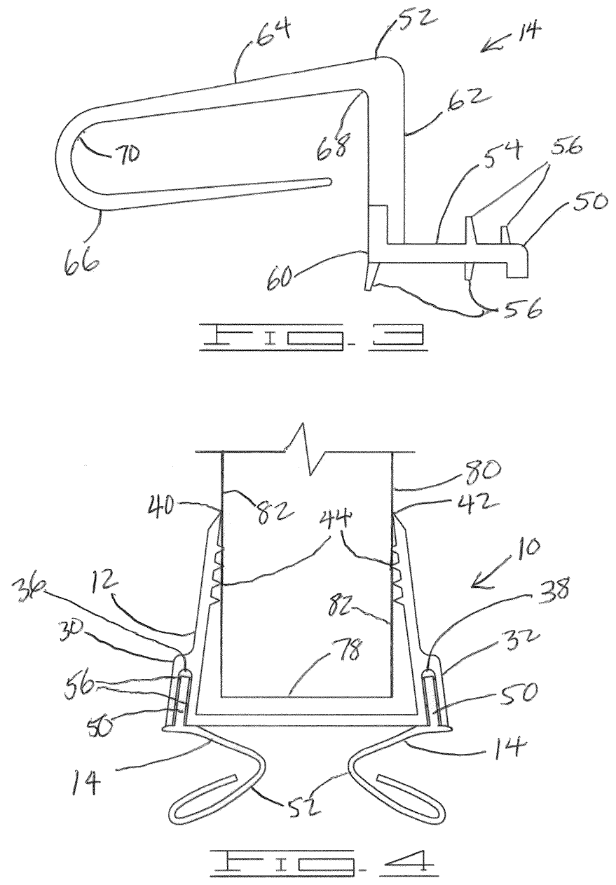

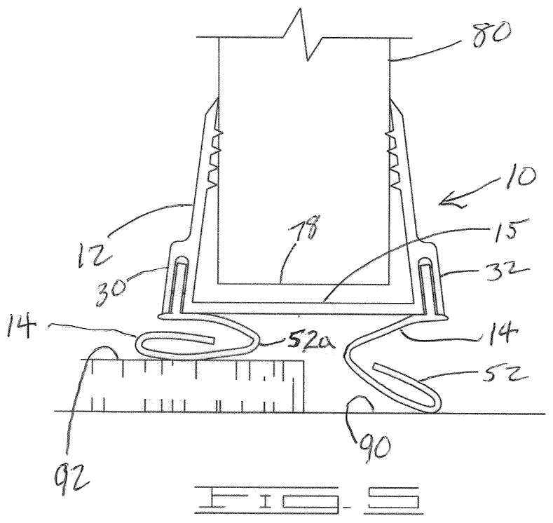

Referring to FIG. 2, the base unit 12 comprises a substantially horizontal bottom 15, a first vertical wall 16, and a second vertical wall 18. The bottom 15 is preferably substantially planar and comprises a first longitudinal edge 20 and a second longitudinal edge 22. The first vertical wall 16 is substantially planar and extends from the first longitudinal edge 20 of the base 12 preferably at an acute angle, terminating at a top edge 24. The second vertical wall 18 is substantially planar and extends from the second longitudinal edge 22 of the base 12 also at an acute angle and terminating at a top edge 25. The bottom 15, the first vertical wall 16, and the second vertical wall 18 generally comprise a substantially “U” shape that will conform to the shape of the bottom of a door (shown in FIG. 4). In preferred use, the acute angles of the vertical walls 16 and 18 allow the under door seal 10 to engage the door in a compression fit such that the walls 16 and 18 contact planar vertical sides of the door at the top edges 24 and 25 of the walls.

Continuing with FIG. 2, the under door seal 10 comprises a plurality of elongate channel guides 30 and 32. The channel guides 30 and 32 preferably comprise a first channel guide 30 disposed proximate the first edge 20 of the base 12 and a second channel guide 32 disposed proximate the second edge 22 of the base. Preferably, the channel guides 30 and 32 each comprise a descending arm 34 extending from an exterior surface of the walls 16 and 18 proximate the bottom 14 of the base unit 12. More preferably the arms 34 extend out from the walls 16 and 18 and downwardly substantially parallel to the walls. The structure and position of the arms 34 of the channel guides 30 and 32 will be understood to define a first channel 36 between the first channel guide 30 and the first wall 16, and a second channel 38 between the second channel guide 32 and the second wall 18.

Further as shown in FIG. 2, the under door seal 10 further comprises a plurality of door contacts adapted to engage planar vertical sides of the door in a manner yet to be shown. The door contacts include a first top seal 40 and a second top seal 42. The first top seal 40 is disposed at the top edge 24 of the first vertical wall 16, and preferably forms an acute angle to the first vertical wall. The second top seal 42 is disposed at the top edge 25 of the second vertical wall 18, and preferably forms an acute angle to the second vertical wall. The door contacts further include a plurality of longitudinal wall ridges 44 protruding from the vertical walls 16 and 18 of the base unit 12. The ridges 44 are preferably spaced vertically along an interior surface of the walls 16 and 18 and proximate the top edges 24 and 25 of the walls.

Preferably, the bottom 15, the vertical walls 16 and 18, and the channel guides 30 and 32 of the base unit 12 are comprised of a rigid plastic as may be known in the art. Additionally, the door contacts comprising the first top seal 40, the second top seal 42, and the wall ridges 44 are preferably comprised of a flexible plastic as may be known in the art. More preferably, the base unit 12 is formed by a coextrusion process as known in the art to permit both the rigid plastic and the flexible plastic to form the separate parts of the integrally formed base unit. One skilled in the art will appreciate the top seals 40 and 42 and the wall ridges 44 form a flexible seal between the vertical walls 16 and 18 and the door (not shown). Notably, the flexible seals 40 and 42 and the ridges 44 provide for a frictional contact against the door to allow a secure positioning of the under door seal 10 on the door bottom as will be shown.

With reference now to FIG. 3, shown therein is an end view of a preferred embodiment for the plurality of elongate sealing fins 14 of the under door seal 10. The sealing fin 14 comprises a rigid channel insert 50 and a flexible fin 52. The rigid channel insert 50 preferably comprises an elongate stem 54 and a plurality of insert tabs 56. The stem 54 comprises a substantially planar strip sized to be received within the first 36 or second 38 channel formed by the base unit 12. The plurality of insert tabs 56 represent protrusions extending from opposing sides 58 of the stem 54. As illustrated in FIG. 3, the plurality of insert tabs 56 preferably comprises multiple tabs on each side 58 of the stem 54, spaced longitudinally along the respective sides. The plurality of tabs 56 function to provide a frictional contact for the channel insert 50 when the insert is positioned in either of the first 36 or second 38 channel of the base unit 12. One skilled the art will appreciate the structure of the stem 54 allows the stem to be slid into either first 36 or second 38 channel of the base unit 12, and may be replaced as needed.

The flexible fin 52 portion of the sealing fin 14 connects to a bottom 60 of the channel insert 50. Preferably the flexible fin 52 comprises a shape and flexibility that allows the fins to fold over and collapse on top of themselves to provide a significant range of compression. To provide for the desired compression of the fin 52, the fin preferably comprises multiple leg segments 62, 64, and 66, approximating a spiral shape. More preferably the fin 52 comprises the first leg 62 extending in a first direction from the bottom 60 of the stem 54. The second leg 64 of the fin 52 extends from a terminal end 68 of the first leg 62 to form an acute angle with the first leg. The third leg 66 of the fin 52 extends from a terminal end 70 of the second leg 64 to form an acute angle with the second leg.

Continuing with FIG. 3, preferably the channel insert 50 of the sealing fin 14 is comprised of a rigid plastic, while the flexible fin 52 is comprised of a flexible plastic. More preferably, the sealing fin 14 is formed using a coextrusion process as known in the industry so the fin may be integrally formed with the rigid plastic of the channel insert 50 and the flexible plastic of the fin 52. In a preferred embodiment the sealing fin 14 may also be coated in a manner known in the industry to prevent friction or drag as the sealing fin engages a floor beneath a door.

Turning now to FIG. 4, there is shown therein the preferred embodiment of the under door seal 10 mounted to a bottom 78 of a representative door 80. The base unit 12 of the door seal 10 is preferably slid onto the door 80. As shown in FIG. 4, a plurality of the door contacts of the base unit 12, comprising the top seals 40 and 42 and the ridges 44, will contact the vertical sides 82 of the door 80 to secure the base unit 12 to the door. The plurality of sealing fins 14 of the door seal 10 are also shown, connected to the base unit 12. Preferably, the channel insert 50 of the sealing fins 14 is slid into the first 36 and second 38 channels defined by the base unit 12. The insert tabs 56 provide a frictional connection to support the channel inserts 50 in the first 36 and second 38 channels.

Referring to FIG. 5, additional benefits and features of the under door seal 10 are shown therein. The door seal 10 may be used advantageously to provide a seal beneath a door 80 where a gap between the bottom 78 of the door and a floor is wide or varied. A recognized feature of the door seal 10 is illustrated in that the base unit 12 may be adjustably positioned on the door 80 to allow a gap between the bottom 78 of the door and the bottom 15 of the base unit 12. Additionally, the door seal 10 may be advantageously used where the door may span two different flooring types. As shown in FIG. 5, the door 80 is illustrated above a first floor type 90 and a second floor type 92, where the first floor type and the second floor type are at different levels. The flexible fin 52 is shown extending to span a gap between the bottom 14 of the base unit 12 and the first floor type 90. The flexible fin 52a is shown compressed to span a gap between the bottom 14 of the base unit 12 and the second floor type 92. As discussed above, the shape and flexible nature of the sealing fins 14 allows for the under door seal 10 to span multiple gap sizes beneath the door 80.

Various modifications can be made in the design and operation of the present invention without departing from the spirit thereof. Thus, while the principal preferred construction and modes of operation of the invention have been explained in what is now considered to represent its best embodiments, which have been illustrated and described, it should be understood that the invention may be practiced otherwise than as specifically illustrated and described.

What is claimed is:

1. An under door bottom seal comprising:
an elongate U-shaped base unit formed by a base, a first vertical wall, and a second vertical wall, the base unit comprising:
a first channel guide extending from the first vertical wall; and
a second channel guide extending from the second vertical wall;
wherein the first vertical wall and the first channel guide define a first channel adjacent the first vertical wall; and
wherein the second vertical wall and the second channel guide define a second channel adjacent the second vertical wall;
a first sealing fin comprising:
a rigid channel insert; and
a flexible fin comprising a plurality of leg segments such that the leg segments approximate a spiral shape; and
a second sealing fin comprising:
a rigid channel insert; and
a flexible fin comprising a plurality of leg segments such that the leg segments approximate a spiral shape;
wherein the first sealing fin is attached to the base unit by inserting the rigid channel insert into the first channel; and
wherein the second sealing fin is attached to the base unit by inserting the rigid channel insert into the second channel.

2. The under door seal of claim 1 wherein the leg segments of each of the flexible fins comprise:
a first leg extending in a first direction from a bottom of the channel insert;
a second leg extending from a terminal end of the first leg to form an acute angle with the first leg; and
a third leg extending from a terminal end of the second leg to form an acute angle with the second leg.

3. The under door seal of claim 1 wherein each of the rigid channel inserts comprises:
a planar stem; and
a plurality of insert tabs protruding from opposing sides of the stem.

4. The under door seal of claim 1 wherein the rigid channel insert of each of sealing fins is comprised of a rigid plastic; and
wherein the flexible fin of each of the sealing fins are comprised of a flexible plastic; and
wherein the sealing fins are formed using a coextrusion process.

5. The under door seal of claim 1 wherein the base unit further comprises:
a plurality of longitudinal wall ridges protruding from an internal surface of the first vertical wall;
wherein the wall ridges are spaced vertically on the first vertical wall proximate a top edge of the wall; and
a plurality of longitudinal wall ridges protruding from an internal surface of the second vertical wall;
wherein the wall ridges are spaced vertically on the second vertical wall proximate a top edge of the wall.

6. The under door seal of claim 5 wherein the plurality of longitudinal wall ridges comprise a flexible plastic; and
wherein the base, the first vertical wall, and the second vertical wall comprise a rigid plastic; and
wherein the base unit is formed using a coextrusion process.

7. An under door bottom seal comprising:
an elongate U-shaped base unit formed by a base, a first vertical wall, and a second vertical wall, the base unit comprising:
a plurality of longitudinal wall ridges protruding from an internal surface of the first vertical wall;
wherein the wall ridges are spaced vertically on the first vertical wall proximate a top edge of the wall;
a plurality of longitudinal wall ridges protruding from an internal surface of the second vertical wall;
wherein the wall ridges are spaced vertically on the second vertical wall proximate a top edge of the wall;
a first channel guide extending from the first vertical wall; and
wherein the first vertical wall and the first channel guide define a first channel adjacent the first vertical wall; and
a second channel guide extending from the second vertical wall;
wherein the second vertical wall and the second channel guide define a second channel adjacent the second vertical wall;
a first sealing fin comprising:
a rigid channel insert; and
a flexible fin comprising:
a first leg extending in a first direction from a bottom of the channel insert;
a second leg extending from a terminal end of the first leg to form an acute angle with the first leg; and
a third leg extending from a terminal end of the second leg to form an acute angle with the second leg;
a second sealing fin comprising:
a rigid channel insert; and
a flexible fin comprising:
a first leg extending in a first direction from a bottom of the channel insert;
a second leg extending from a terminal end of the first leg to form an acute angle with the first leg; and
a third leg extending from a terminal end of the second leg to form an acute angle with the second leg;
wherein the first sealing fin is attached to the base unit by inserting the rigid channel insert into the first channel; and
wherein the second sealing fin is attached to the base unit by inserting the rigid channel insert into the second channel.

8. The under door seal of claim 7 wherein each of the rigid channel inserts comprises:
a planar stem; and
a plurality of insert tabs protruding from opposing sides of the stem.

9. The under door seal of claim 7 wherein the rigid channel insert of each of sealing fins is comprised of a rigid plastic; and
wherein the flexible fin of each of the sealing fins are comprised of a flexible plastic; and
wherein the sealing fins are formed using a coextrusion process.

10. The under door seal of claim 7 wherein the plurality of longitudinal wall ridges comprise a flexible plastic; and
wherein the base, the first vertical wall, and the second vertical wall comprise a rigid plastic; and
wherein the base unit is formed using a coextrusion process.
